(19) United States
(12) Patent Application Publication
(10) Pub. No.: US 2014/0117938 A1
(43) Pub. Date: May 1, 2014

(54) BATTERY BALANCING CONVERTER COMPRISING DIAGNOSTIC MEANS

(71) Applicant: IFP Energies nouvelles, Rueil-Malmaison Cedex (FR)

(72) Inventors: Hichame OUZAAROU, Aulnay Sous Bois (FR); Morgan ALMANZA, Prades-Le-Lez (FR)

(73) Assignee: IFP ENERGIES NOUVELLES, Rueil-Malmaison Cedex (FR)

(21) Appl. No.: 14/058,315

(22) Filed: Oct. 21, 2013

(30) Foreign Application Priority Data
Oct. 25, 2012 (FR) 12/02849

(51) Int. Cl. H02J 7/00

(52) U.S. Cl. CPC H02J 7/0014
USPC 320/134

(57) ABSTRACT

The invention relates to a converter for balancing the charge of cells (C) of a battery. The converter is a non-dissipative type with a switched structure (MC) and balancing means. The converter further comprises diagnostic means (DIA) connected to switch matrix (MC) of the switched structure.

### CROSS REFERENCE TO RELATED APPLICATION

Reference is made to French Patent Application Serial No. 12/02.849, filed on Oct. 25, 2012, which application is incorporated herein by reference in its entirety.

### BACKGROUND OF THE INVENTION

1. Field of the Invention

The present invention relates to the sphere of balancing the charge of electric batteries, in particular for electric or hybrid motor vehicles.

2. Description of the Prior Art

When a battery is used in an electric or hybrid vehicle, the cells making up the battery undergo charge and discharge cycles. The dispersion of the characteristics of the various cells, in particular the faradaic efficiency, causes charge imbalances during the life of the battery. The cells must remain within a well-defined operating range.

In order to maintain the battery capacity while extending its life and safe use, balancing the various cells that make up the battery is essential. Balancing transfers charges between the cells so that they all have the same state of charge. Indeed, as soon as a cell is outside its operating range, the entire battery is affected. To maintain the best battery performance, the balancing system must affect each cell. A voltage decrease is a negative factor for the conversion of energy. Furthermore, for the balancing system to be efficient, the state of charge of each cell has to be known.

In the literature, several solutions are provided for balancing battery cells. These solutions can be classified into two families which are dissipative and non-dissipative.

In the case of the first family, implementation is simple with part of the energy of the most charged cells being dissipated, in a resistor for example, which decreases the charge of these cells and therefore of the battery.

In the case of non-dissipative systems, the charges are transferred from one cell to the next through charge or discharge of cells. These non-dissipative systems can be classified into three categories having:
a structure referred to as “switched”: which routes the output of a single static converter to the desired cell, using a matrix (or set) of controlled switches, also referred to as switch matrix. This technique uses a limited number of components, which allows the size thereof to be reduced. This type of structure is notably described in the following documents:
   Fast Battery Equalization with Isolated Bidirectional DC-DC Converter for PHEV Applications , Ziling Nie and Chris Mi, Department of Electrical and Computer Engineering, University of Michigan Dearborn, Journal IEEE 2009,
   Battery Cell Balancing: What to Balance and How, Yevgen Barsukov, Texas instruments;
a “series” structure: which places a static converter between two successive cells. Generally, these structures comprise a large number of components and only allow transfers between successive cells;
a “parallel” structure of static converters allowing direct coupling of all the cells with one another via galvanic isolation. In general, these structures are more complex to operate because a single converter controls several cells and requires using an isolation transformer. This isolation transformer has the drawback of being heavy, which is incompatible with integration on board a vehicle. To overcome this drawback, increasing the switching frequency has been considered, but this method considerably increases the switching and conduction losses, as well as the electromagnetic interferences.

Whether dissipative or non-dissipative, balancing systems do not enable diagnostics to be made for each battery. Indeed, currently used diagnostic tools, such as impedance spectroscopy, cannot be installed on board vehicles because they are bulky and require material independent of the balancing system.

### SUMMARY OF THE INVENTION

In order to overcome these drawbacks, the invention is a non-dissipative converter with a switched structure and further comprises a diagnostic means or system connected to the switch matrix of the switched structure. Thus, the diagnostic means or system can be used on board and the switch matrix can be used for diagnostic and balancing of all the cells with a limited spatial requirement.

The converter of the invention for balancing the cells of an electrical battery, comprises a switch matrix with a plurality of switches connected to the cells, and balancing means or system connected to the switch matrix that can charge and/or discharge each one of the cells through control of the switch matrix. The converter also comprises cell diagnostic means or system, the diagnostic means or system being connected to the switch matrix in such a way that a switch control enables connection of the diagnostic means or system to any cell to be diagnosed.

According to the invention, the diagnostic means or system notably determines the state of charge and/or the state of health of the at least one cell.

Advantageously, the diagnostic means or system enables performing an electrochemical impedance spectroscopy.

Preferably, the diagnostic means or system is at least one circuit comprising a current source and a voltage sensor.

Advantageously, the current source is supplied by the battery.

According to an embodiment of the invention, the balancing means or system comprises a static converter of cell to cell or cell to battery or battery to cell or a bidirectional type.

the switches can be semi-conductor switches, notably of a MOSFET type, or static relays.

Advantageously, the balancing means or system and the diagnostic means or system are used alternately.

Advantageously, balancing of the charge is performed according to at least one previously established diagnostic.

According to an embodiment of the invention, the battery comprises lithium-ion cells.

The invention also relates to an electrical or hybrid vehicle, notably a motor vehicle, comprising an electrical battery having a plurality of cells. The vehicle comprises a balancing converter as defined above for balancing the charge of the cells.

### BRIEF DESCRIPTION OF THE DRAWINGS

Other features and advantages of the method according to the invention will be clear from reading the description hereafter of embodiments given by way of non limitative example, with reference to the accompanying figures wherein:

FIG. 1 is a diagram showing the balancing converter according to the invention;

FIG. 2 shows a DCDC converter used by the invention;

FIG. 3 shows the switch matrix and the balancing means or system for a balancing converter according to a first embodiment of the invention;

FIG. 4 shows the switch matrix and the balancing means or system for a balancing converter according to a second embodiment of the invention;

FIG. 6 shows diagnostic means for a balancing converter according to the invention;

FIG. 7 illustrates a balancing converter according to the first embodiment of the invention;

FIG. 8 illustrates a balancing converter according to the second embodiment of the invention; and

FIG. 9 illustrates a balancing converter according to a fourth embodiment of the invention.

### DETAILED DESCRIPTION OF THE INVENTION

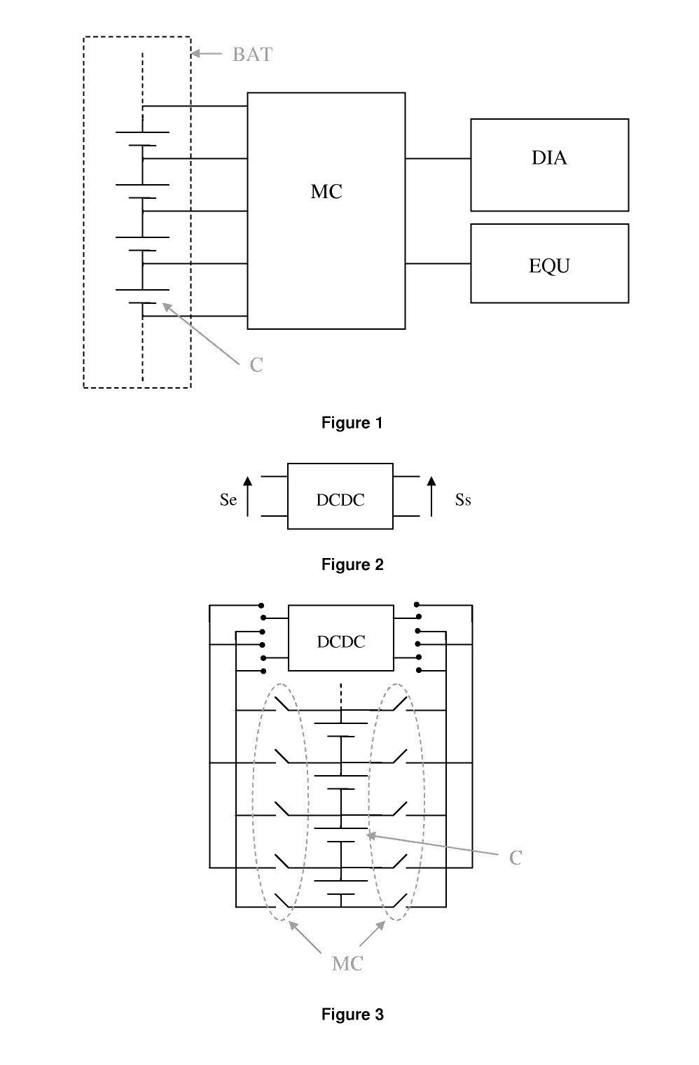

FIG. 1 diagrammatically shows a balancing converter according to the invention. The converter according to the invention allows the charge of cells (C) of a battery (BAT) to be balanced. The converter comprises a switch matrix (MC) having a plurality of controlled switches and connected to cells (C), and balancing means or system (EQU) connected to the switch matrix (MC) that can charge and/or discharge each cell (C). According to the invention, the converter is of non-dissipative type and the structure thereof is referred to as switched. The switches of switch matrix (MC) are controlled so as to charge or discharge a cell (C). Besides, the converter according to the invention comprises diagnostic means or system (DIA) for diagnosing at least one cell (C) of battery (BAT). The assembly according to the invention includes a single isolated static converter that “slides” onto the cell to be balanced via switch matrix (MC) with the operation being similar for the cell to be diagnosed. Through this pooling of the switch means or system, the diagnostic means or system can be integrated on board with the number of components used being limited and the size of the balancing converter being reduced.

The diagnostic means or system (DIA) are understood to enable testing of the state of cells (C) of battery (BAT), notably through determination of their state of charge, denoted by SoC, and their state of health, denoted by SoH, which represents the aging of the cell. Preferably, for determination of the state of charge and the state of health, an impedance is determined with an electrochemical impedance spectroscopy (EIS) technique. The electrochemical impedance of a cell is defined as the transfer function between the potential difference at the cell terminals and the current flowing therethrough. It is a complex quantity that is generally determined by frequency analysis of the response of an excitation signal. In principle, any type of excitation can be used. The literature mentions three particularly interesting types of excitation suited to the diagnostic means or system according to the invention, which are:
a) sinusoidal excitation signal at different frequencies. The quantities ΔI=Iₘₐₓsin(2πf t) and ΔV=Vₘₐₓsin(2πf t+φ) are calculated to determine the impedance by using a formula of the following type:

$$Z ( f ) = \frac{{V}_{max}}{{I}_{max}} {e}^{j φ} ,$$

b) impulse signal with the measurement being referred to as impulse impedance measurement. The following document describes a method using this type of excitation: “Diagnostic de Batteries Lithium-ion dans des Applications Embarquées, Dinh Vinh Do, Laboratoire d'électromecanique de Compiègne, 2010”,
c) random excitation signal based on the noise present in the cells. French Patent Application 2,956,743 A describes a method using this technique.

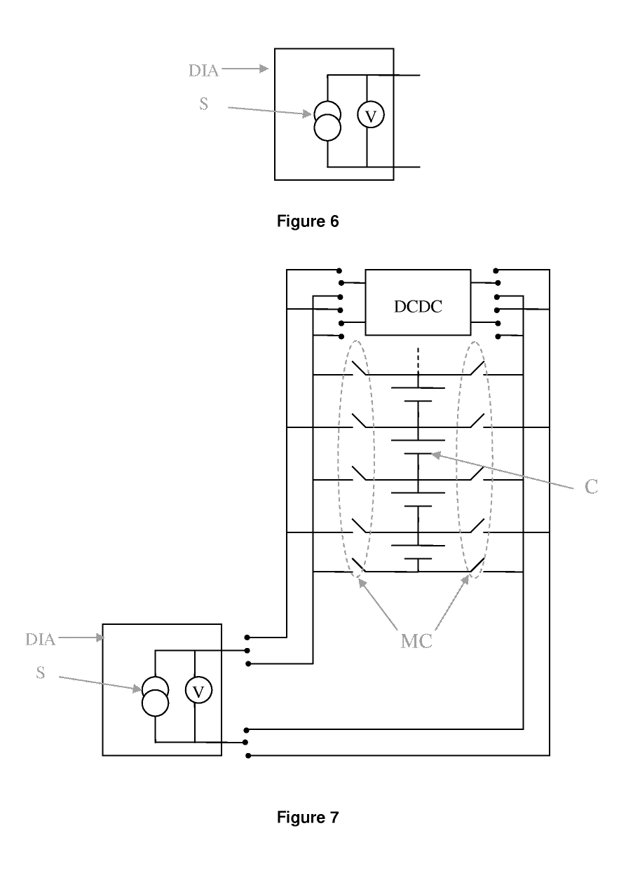

FIG. 6 shows the diagnostic means or system (DIA) that can be used for the balancing converter according to the invention. As shown, diagnostic means (DIA) or system enables performing an electrochemical impedance spectroscopy using a current source (S) for the excitation (for example by generating a sinusoidal or impulse signal) and a voltage sensor or a voltmeter (V) for measuring the voltage. Preferably, the current source (S) is supplied by the battery. The impedance is then determined through analysis of the signal. the state of charge SoC and the state of health SoH are deduced therefrom.

Integration of the balancing and diagnostic functions is allowed because the switch matrix enables “spatiotemporal” multiplexing. On the one hand, spatial multiplexing allows the two functions to be achieved alternately and, on the other hand, temporal multiplexing is used because the functions do not need to be achieved at the same time.

According to the invention, the balancing means or system (EQU) can implement by one of the four balancing techniques which are: cell to cell, cell to battery, battery to cell or bi-directional. According to the balancing technique selected, a static converter suited for energy transfer is defined. It is noted that a static converter as shown in FIG. 2 is a system allowing adapting a source of electric power (Se) to a given receiver or output source (Ss). A DCDC static converter, optionally with a galvanic isolation, allows obtaining a ripple voltage of adjustable mean value from a fixed voltage source. This type of static converter is also referred to as chopper.

Depending on the type of input (Se) and output (Ss) sources (see FIG. 2) to be connected, there are four types of DCDC converters:
a series chopper for connecting an input voltage source to an output current source;
a parallel chopper for connecting an input current source to an output voltage source;
a capacitive storage chopper for connecting two current sources; and
an inductive storage chopper for connecting two voltage sources.

The characteristics of the static converter depend on the balancing technology which are summed up in Table 1.

TABLE 1
Characteristics of the static converter

| | Selection of the static converter (CS) | | | |
|---|---|---|---|---|
| Balancing | | Current | Step up/ | |
| techniques | Isolation | reversibility | step down | Type |
| Cell to cell | Yes | yes | both | Static |
| Cella to battery | Yes | no | step up | converter of |
| Battery to cell | Yes | no | step down | inductive |
| Bidirectional | Yes | yes | both | storage |
| | | | | chopper type |
| | | | | (ex: Flyback) |

FIGS. 3 to 5 show various switch matrices associated with their static converter for different energy transfer techniques. In these figures and in FIGS. 7 to 9, a set of three non-connected points indicates the presence of a switch that can close one part of the circuit or the other.

For energy transfer from a cell X to any cell Y, the configuration of FIG. 2 can be used. The switch matrix (MC) is made up of 2N+2 switches for N cells (C). According to this embodiment, the switches of switch matrix (MC) are closed so as to connect the least charged cell to the most charged cell in order to enable their respective charge and discharge. For this embodiment, the inlet of the static converter (DCDC) can be connected to a cell to be discharged through closing of two switches of switch matrix (MC), and the outlet of the static converter can be connected to a cell to be charged through closing of two switches of switch matrix (MC). A non-reversible DCDC type static converter allows all of the desired transfers to take place. It is noted that it is also possible, with this configuration, to perform battery to cell transfers, and vice versa, with a suitable sizing of the DCDC static converter and appropriate control of switch matrix (MC).

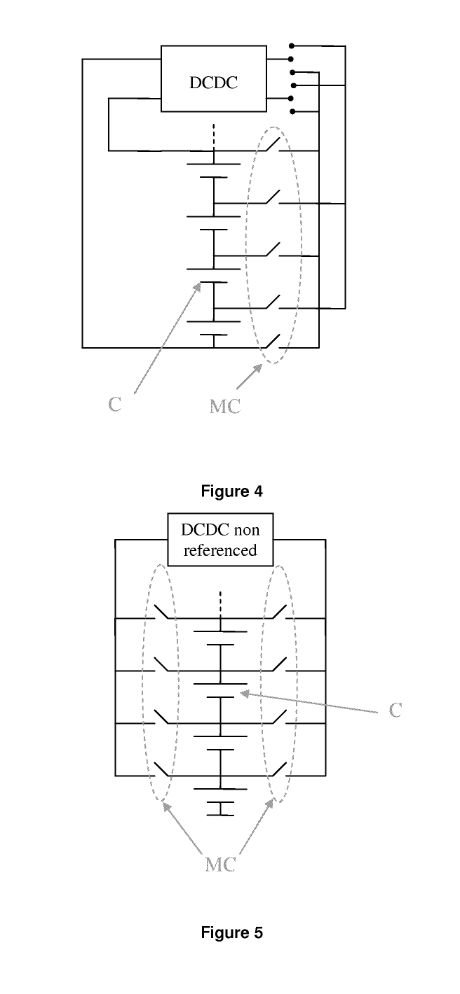

Alternatively, if only battery to cell transfers are conducted, the configuration of FIG. 4 is more suitable. This solution uses a limited number of switches for switch matrix (MC) in relation to the previous solution: for this embodiment, N+1 switches are used for N cells (C). The inlet of the static converter is connected to the battery (that is to all the cells) and its outlet can be connected to a cell (C) to be charged through closing of two switches. If bidirectional transfers are desired, a reversible DCDC static converter is used or, if the transfers occur in one direction only, a non-reversible DCDC static converter is used.

According to a third embodiment of the invention, a non-referenced (in relation to the 0V battery) DCDC static converter connected to switch matrix (MC) can be used. This type of converter affords the advantage of being sized for low voltages (corresponding to the potential difference between two cells). FIG. 4 shows a set-up of the balancing means or system according to this embodiment with the switch matrix (MC) comprising in this case 2N switches for N cells (C).

Switch matrix (MC) can be:
MOSFET type semi-conductor switches (i.e. a Metal Oxide Semiconductor Field

Effect Transistor), or
static relays (or SSR: Solid State Relays), which are entirely isolated and inexpensive switches up to 1A, marketed as integrated circuits comprising 2 or 4 switches.

In both cases, the sizing of switch matrix (MC) depends on the Ieq_max/Qeq_max ratio and the ratio of the maximum balancing current to the maximum amount of charge to be transferred per cell.

FIGS. 7 to 9 show balancing converters according to the invention with various balancing means or systems.

FIG. 7 corresponds to the first embodiment of FIG. 3 (cell to cell transfer) where the diagnostic means (DIA) illustrated in FIG. 6 having been added.

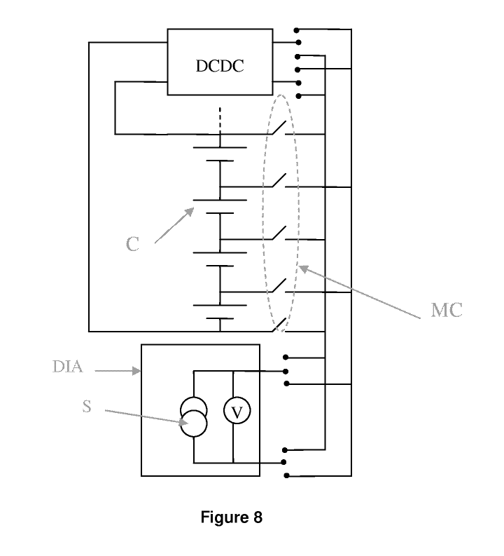

FIG. 8 corresponds to the second embodiment of FIG. 8 (battery to cell transfer) where the diagnostic means or system (DIA) illustrated in FIG. 6 have been added.

The invention has the advantage of having a single powerful excitation source (that can be supplied by the battery) and a single static converter. However, there are several switch matrix (MC) configurations allowing pooling of the diagnostic and balancing electronics.

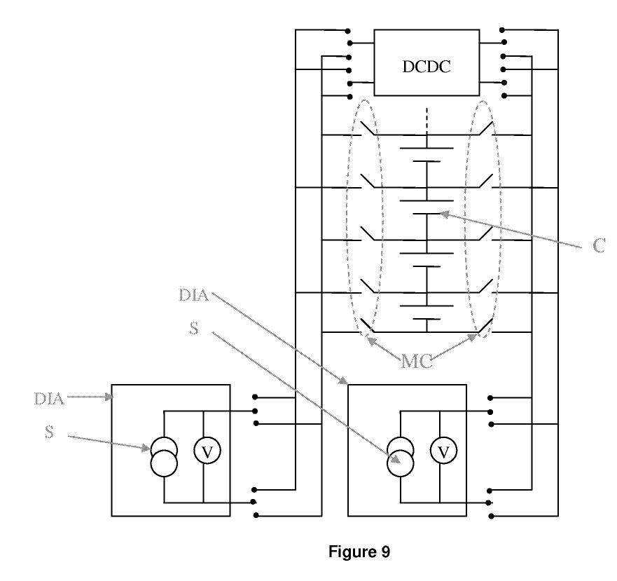

If switch matrix (MC) allows, performance of two (or more) impedance measurements simultaneously is possible. The diagnostic means or system can therefore include two circuits with each having a current source (S) and a voltage sensor or a volt meter (V). FIG. 9 is an illustration thereof for cell to cell balancing (corresponding to FIG. 3). The fourth embodiment allows time to be saved during the diagnostic.

In order to balance the charge of the cells and to perform the diagnostic, the switches of switch matrix (MC) are controlled. Various algorithms can be used for controlling the opening and closing of the switches of switch matrix (MC) in the case of balancing. The most charged cell and the least charged cell can notably be detected, and the least charged cell is charged by the most charged cell with this operation being repeated until the charge difference between the various cells is below a given threshold. The detection of the state of charge of the cells uses the diagnostics previously obtained with diagnostic means or system (DIA). Different diagnostic strategies can be used for controlling the switches of switch matrix (MC) in the case of performing a diagnostic. Each cell can for example be diagnosed one after the other (or in a pre-established order) with particular cells being diagnosed first according to a log (behavior of the cell under cycling). This control of the switch matrix is achieved by the battery management system (BMS).

The balancing converters according to the invention can be used for any type of battery, but they are particularly well suited to lithium-ion batteries. Indeed, for this technology, a poorly controlled charge can lead to the destruction of the accumulator.

The invention can be integrated on board electrical or hybrid vehicles comprising a battery, the vehicles being notably motor vehicles.

1-11. (canceled)

12. A converter for balancing cells of an electric battery comprising:
a switch matrix including a plurality of switches connected to the cells, a balancing system connected to the switch matrix for at least one of charging and discharging each cell by controlling the switch matrix; and wherein
the balancing system includes a cell diagnostic system connected to the switch matrix so that switching control enables connection of the diagnostic system to any cell to be diagnosed.

13. A converter as claimed in claim 12, wherein the diagnostic system determines at least one of a state of charge and a state of health of at least one cell.

14. A converter as claimed in claim 12, wherein the diagnostic system enables performing an electrochemical impedance spectroscopy.

15. A converter as claimed in claim 13, wherein the diagnostic system enables performing an electrochemical impedance spectroscopy.

16. A converter as claimed in claim 14, wherein the diagnostic system comprises at least one circuit comprising a current source and a voltage sensor.

17. A converter as claimed in claim 15, wherein the diagnostic system comprises at least one circuit comprising a current source and a voltage sensor.

18. A converter as claimed in claim 16, wherein the current source is supplied by the battery.

19. A converter as claimed in claim 17, wherein the current source is supplied by the battery.

20. A converter as claimed in claim 12, wherein the balancing system comprises a static converter comprising one of a cell to cell type, a cell to battery type, a battery to cell type or a bidirectional type.

21. A converter as claimed in claim 13, wherein the balancing system comprises a static converter comprising one of a cell to cell type, a cell to battery type, a battery to cell type or a bidirectional type.

22. A converter as claimed in claim 14, wherein the balancing system comprises a static converter comprising one of a cell to cell type, a cell to battery type, a battery to cell type or a bidirectional type.

23. A converter as claimed in claim 15, wherein the balancing system comprises a static converter comprising one of a cell to cell type, a cell to battery type, a battery to cell type or a bidirectional type.

24. A converter as claimed in claim 16, wherein the balancing system comprises a static converter comprising one of a cell to cell type, a cell to battery type, a battery to cell type or a bidirectional type.

25. A converter as claimed in claim 17, wherein the balancing system comprises a static converter comprising one of a cell to cell type, a cell to battery type, a battery to cell type or a bidirectional type.

26. A converter as claimed in claim 18, wherein the balancing system comprises a static converter comprising one of a cell to cell type, a cell to battery type, a battery to cell type or a bidirectional type.

27. A converter as claimed in claim 19, wherein the balancing system comprises a static converter comprising one of a cell to cell type, a cell to battery type, a battery to cell type or a bidirectional type.

28. A converter as claimed in claim 12, wherein the switches comprise semi-conductor switches or static relays.

29. A converter as claimed in claim 13, wherein the switches comprise semi-conductor switches or static relays.

30. A converter as claimed in claim 14, wherein the switches comprise semi-conductor switches or static relays.

31. A converter as claimed in claim 16, wherein the switches comprise semi-conductor switches or static relays.

32. A converter as claimed in claim 18, wherein the switches comprise semi-conductor switches or static relays.

33. A converter as claimed in claim 20, wherein the switches comprise semi-conductor switches or static relays.

34. A converter as claimed in claim 12, wherein the balancing system and the diagnostic system are used alternately.

35. A converter as claimed in claim 13, wherein the balancing system and the diagnostic means system are used alternately.

36. A converter as claimed in claim 14, wherein the balancing system and the diagnostic system are used alternately.

37. A converter as claimed in claim 16, wherein the balancing system and the diagnostic system are used alternately.

38. A converter as claimed in claim 18, wherein the balancing system and the diagnostic system are used alternately.

39. A converter as claimed in claim 20, wherein the balancing system and the diagnostic system are used alternately.

40. A converter as claimed in claim 28, wherein the balancing system and the diagnostic system are used alternately.

41. A converter as claimed in claim 13, wherein the balancing system balances charge using a previously developed diagnostic routine.

42. A converter as claimed in claim 12, wherein the battery comprises lithium-ion cells.

43. A converter according to claim 12, comprising a hybrid motor vehicle wherein the converter balances cells of the vehicle.
